(19) United States
(12) Patent Application Publication
(10) Pub. No.: US 2022/0089919 A1
(43) Pub. Date: Mar. 24, 2022

(54) THERMALLY CONDUCTIVE SHEET AND METHOD FOR PRODUCING THERMALLY CONDUCTIVE SHEET

(71) Applicant: DEXERIALS CORPORATION, Shimotsuke-shi, Tochigi (JP)

(72) Inventors: Yusuke KUBO, Shimotsuke-shi, Tochigi (JP); Keisuke ARAMAKI, Shimotsuke-shi, Tochigi (JP)

(73) Assignee: DEXERIALS CORPORATION, Shimotsuke-shi, Tochigi (JP)

(21) Appl. No.: 17/424,617

(22) PCT Filed: Jan. 21, 2020
(86) PCT No.: PCT/JP2020/001918

§ 371 Date: Jul. 21, 2021

(30) Foreign Application Priority Data
Jan. 25, 2019 (JP) 2019-011149

(51) Int. Cl. C09J 11/04; C09K 5/14; C09J 7/38; C09J 7/25; B29C 69/00; B05D 5/10

(52) U.S. Cl. CPC C09J 11/04; C09K 5/14; C09J 7/385; C09J 7/25; B29C 69/001; B29K 2083/00; C09J 2203/326; C09J 2301/41; C09J 2483/006; C09J 2433/00; B05D 5/10

(57) ABSTRACT

A thermally conductive sheet includes a sheet body and an adhesive layer. The sheet body is obtained by curing a thermally conductive resin composition. The thermally conductive resin composition includes a polymer matrix component and a fibrous thermally conductive filler. The adhesive layer is formed on at least one surface of the sheet body and imparts tackiness to the at least one surface of the sheet body. A volume of the adhesive layer is 0.0002 cm³ or more and 0.001 cm³ or less per 1 cm² of the sheet body.

### TECHNICAL FIELD

This technology relates to a thermally conductive sheet that is attached to an electronic component or the like to improve its heat dissipation, and a method for producing the thermally conductive sheet. This application claims priority on the basis of Japanese Patent Application No. 2019-011149 filed on Jan. 25, 2019 in Japan, and this application is incorporated herein by reference.

### BACKGROUND ART

As electronic devices become even more sophisticated, electronic components such as semiconductor devices are becoming increasingly dense and highly mounted. Accordingly, in order to more efficiently dissipate heat generated from electronic components constituting electronic devices, thermally conductive sheets are provided for use between various heat sources (for example, various devices such as LSIs, CPUs, transistors, LEDs, and the like) and heat dissipating members, such as heat sinks (for example, heat dissipating fans, heat dissipating plates, and the like).

A widely used thermally conductive sheet is formed by slicing a sheet from a cured product that is cured after molding a thermally conductive resin composition containing a thermally conductive filler such as an inorganic filler in a polymer matrix.

### CITATION LIST

### Patent Literature

Patent Literature 1: Japanese Patent No. 5766335

Patent Literature 2: Japanese Patent No. 5752299

### SUMMARY OF THE INVENTION

### Technical Problem

There is demand for such a thin thermally conductive sheet with high thermal conductivity to reduce the thermal resistance between various heat sources and heat-dissipating members. However, with the method of manufacturing a thermally conductive sheet by slicing the cured product of a thermally conductive resin composition, the surface of the thermally conductive sheet formed by slicing has no tackiness, while there is a case where tackiness (adhesiveness), such as adhering to an adherend, is required for the thermally conductive sheet from the perspective of handling.

Therefore, technology has been disclosed in which a thermally conductive sheet, obtained by preparing a thermally conductive resin composition by changing the ratio of silicone agent A and silicone agent B, is pressed, or placed between PET films and allowed to sit, thereby causing the components that do not contribute to the reaction to bleed out, enhancing the adhesion to an adherend (for example, Patent Literatures 1 and 2).

However, if the ratio of silicone A is increased, the sheet becomes highly flexible and easily adheres to the adherend, but there may be problems with peeling properties such as stretching or tearing of the thermally conductive sheet when the thermally conductive sheet is peeled from a release film. In addition, the flexibility of the thermally conductive sheet could cause long-term reliability problems due to creep in environments where a constant load is applied.

Therefore, an object of the present technology is to provide a thermally conductive sheet having tackiness on a surface of the sheet and improved handling properties, and a method for producing the thermally conductive sheet.

### Solution to Problem

In order to solve the above-mentioned problem, a thermally conductive sheet according to the present technology includes: a sheet body obtained by curing a thermally conductive resin composition comprising at least a polymer matrix component and a fibrous thermally conductive filler; and an adhesive layer formed on at least one surface of the sheet body, wherein the volume of the adhesive layer is 0.0002 cm³ or more and 0.001 cm³ or less per 1 cm² of the sheet body.

In addition, the method for producing a thermally conductive sheet according to the present technology includes: a step of molding a thermally conductive resin composition containing a fibrous thermally conductive filler in a polymer matrix component into a predetermined shape and curing the composition to form a thermally conductive molded body; a step of slicing the thermally conductive molded body into a sheet to form a molded body sheet; and a step of forming an adhesive layer on at least one surface of the molded body sheet, wherein the volume of the adhesive layer is 0.0002 cm³ or more and 0.001 cm³ or less per 1 cm² of the sheet body of the molded body sheet.

### Advantageous Effect of Invention

With the present technology, the thermally conductive sheet has tackiness due to the adhesive layer and favorable handling properties due to the silicone resin layer formed on the sheet body, and therefore, there is no problem with the properties of peeling from the release film due to bleeding of uncured components of the polymer matrix component. In addition, the thermally conductive sheet with the present technology does not have a problem with long-term reliability caused by excessive flexibility.

### BRIEF DESCRIPTION OF DRAWINGS

FIG. 1 is a cross-sectional view showing an example of a thermally conductive sheet to which the present technology is applied.

FIG. 2 is a perspective view showing an example of a process of slicing a thermally conductive molded body.

FIG. 3 is a cross-sectional view showing an example of a semiconductor device.

### DESCRIPTION OF EMBODIMENTS

Hereinafter, the thermally conductive sheet to which the present technology is applied and the method for producing the thermally conductive sheet will be described in detail with reference to the drawings. It should be noted that the present technology is not limited to the following embodiments, and it goes without saying that various changes can be made without departing from the gist of the present technology. In addition, the drawings are schematic and the ratio of each dimension may differ from the actual one. Specific dimensions, etc., should be determined in consideration of the following explanation. In addition, naturally, there are portions in which the relationships and proportions of the dimensions differ between the drawings.

The thermally conductive sheet to which the present technology is applied includes a sheet body obtained by curing a thermally conductive resin composition containing at least a polymer matrix component and a fibrous thermally conductive filler, and an adhesive layer formed on at least one surface of the sheet body. The volume of the adhesive layer is 0.0002 cm³ or more and 0.001 cm³ or less per 1 cm² of the sheet body.

The thermally conductive sheet to which the present technology is applied has tackiness due to the adhesive layer, and since the adhesive layer is formed on the sheet body, it does not have a problem with the peeling property from the release film due to the bleeding of the uncured component of the polymer matrix component, and it has good handling property. In addition, the thermally conductive sheet to which the present technology is applied does not have the problem with long-term reliability due to excessive flexibility. Furthermore, the thermally conductive sheet to which the present technology is applied can suppress an increase in thermal resistance and maintain thermal conduction efficiency while having an adhesive layer that imparts tackiness.

In addition, when the volume of the adhesive layer is less than 0.0002 cm³ per 1 cm² of sheet body, the expression of tackiness on the sheet surface becomes insufficient. When the volume of the adhesive layer exceeds 0.001 cm³ per 1 cm² of the sheet body, the thermal resistance may increase and the thermal conductivity may deteriorate.

The adhesive layer of the thermally conductive sheet to which the present technology is applied is preferably composed of an acrylic adhesive.

In addition, the adhesive layer of the thermally conductive sheet to which the present technology is applied is preferably formed on one surface of the sheet body, and the other surface of the sheet body is preferably non-adhesive. The thermally conductive sheet has adhesiveness on one surface and non-adhesiveness on the other surface, so that the handling property can be improved and the increase in thermal resistance can be further suppressed.

In terms of the thermally conductive sheet, it is preferable that the polymer matrix component constituting the sheet body is a liquid silicone component and the fibrous thermally conductive filler is carbon fiber.

### [Thermally Conductive Sheet]

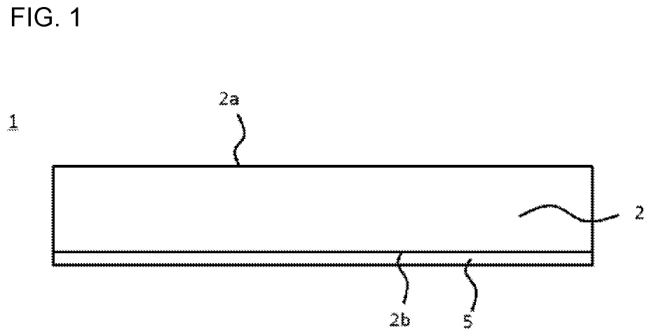

FIG. 1 shows the thermally conductive sheet 1 to which the present technology is applied. The thermally conductive sheet 1 has a sheet body 2 obtained by curing a thermally conductive resin composition containing at least a polymer matrix component and a fibrous thermally conductive filler, wherein an adhesive layer 5 is formed on at least one surface of the sheet body 2.

The sheet body 2 has reduced or no tackiness (adhesiveness) on the front surface 2a and the back surface 2b. Herein, reduced or no tackiness means that the tackiness is reduced to an extent that a person does not feel tack when touching, thereby improving the handling and workability of the thermally conductive sheet 1. Note that with the thermally conductive sheet 1, some uncured components of the polymer matrix component may ooze out from the sheet body 2 and cover the thermally conductive filler exposed on the front and back surfaces 2a and 2b, but this does not cause the sheet body 2 to develop tackiness. As described below in detail, tackiness of the thermally conductive sheet 1 is achieved by a silicone resin layer 5 which is formed on the sheet body 2.

(Polymer Matrix Component)

The polymer matrix component that forms the sheet body 2 is a polymer component that serves as a base material for the thermally conductive sheet 1. The type of the polymer is not particularly limited, and any known polymer matrix component can be selected as appropriate. For example, one of the polymer matrix components can be a thermosetting polymer.

Examples of the thermosetting polymer include crosslinked rubber, epoxy resin, polyimide resin, bismaleimide resin, benzocyclobutene resin, phenol resin, unsaturated polyester, diallyl phthalate resin, silicone resin, polyurethane, polyimide silicone, thermosetting polyphenylene ether, thermosetting modified polyphenylene ether, and the like. These may be used individually, or two or more may be used in combination.

Note that the aforementioned cross-linked rubber includes, for example, natural rubber, butadiene rubber, isoprene rubber, nitrile rubber, hydrogenated nitrile rubber, chloroprene rubber, ethylene-propylene rubber, chlorinated polyethylene, chlorosulfonated polyethylene, butyl rubber, halogenated butyl rubber, fluoro rubber, urethane rubber, acrylic rubber, polyisobutylene rubber, silicone rubber, and the like. These may be used individually, or two or more may be used in combination.

Of these thermosetting polymers, a silicone resin is preferably used because of the excellent molding processability and weather resistance as well as close adhesiveness and following properties to electronic components. The silicone resin is not particularly limited, and the type of silicone resin can be selected based on the objective.

From the viewpoint of obtaining the molding processability, weather resistance, close adhesiveness, and the like, the silicone resin is preferably a silicone resin containing a liquid silicone gel as a main agent and a curing agent. Examples of the silicone resin include addition-reaction type liquid silicone resins and thermally vulcanized millable silicone resins using peroxides for vulcanizing, and the like. Of these, an addition-reaction type liquid silicone resin is particularly preferred for use as a heat-dissipating component in electronic equipment, because close adhesion is required between the heat-generating surface of the electronic component and the heat sink surface.

The addition-reaction type liquid silicone resin is preferably a two-component addition-reaction type silicone resin, such as a polyorganosiloxane having a vinyl group as the main agent and a polyorganosiloxane having a Si—H group as the curing agent.

Here, the liquid silicone component has a silicone A liquid component, which is the main agent, and a silicone B liquid component, which contains a curing agent, and the silicone A liquid component and the silicone B liquid component are blended in a predetermined ratio. The blending ratio of the silicone A liquid component and the silicone B liquid component can be adjusted as appropriate but is preferably set so as to provide flexibility to the sheet body 2 and to improve handling properties by providing non-tackiness to the surfaces of the sheet body 2 without excessive bleeding of uncured components of the polymer matrix component to the surfaces 2a, 2b of the sheet body 2 due to a pressing step.

Furthermore, the content of the polymer matrix component in the thermally conductive sheet 1 is not particularly limited and can be selected based on the objective, but from the viewpoint of ensuring the molding processability of the sheet and the close adhesiveness of the sheet, the amount is preferably approximately 15% to 50% by volume, more preferably 20% to 45% by volume.

(Fibrous Thermal Conductive Filler)

The fibrous thermally conductive filler contained in the thermally conductive sheet 1 is a component for improving the thermal conductivity of the sheet. The type of the thermally conductive filler is not particularly limited as long as being a fibrous material with high thermal conductivity, but carbon fiber is preferable for obtaining higher thermal conductivity.

Note that one type of thermally conductive filler may be used individually, or two or more types may be blended together. Furthermore, when two or more types of thermally conductive fillers are used, the fillers may all be fibrous thermally conductive fillers, or a mixture of fibrous thermally conductive fillers and other forms of thermally conductive filler may be used. Other forms of thermally conductive fillers include metals such as silver, copper, and aluminum, ceramics such as alumina, aluminum nitride, silicon carbide, and graphite, and the like.

There is no particular limitation on the type of carbon fiber, and the type can be appropriately selected based on the objective. Examples that can be used include pitch-based, PAN-based, and graphitized PBO fibers, as well as those synthesized by an arc discharge method, laser evaporation method, CVD method (chemical vapor deposition method), CCVD method (catalytic chemical vapor deposition method), and the like. Of these, graphitized PBO fibers and pitch-based carbon fibers are more preferable because of the high thermal conductivity.

The carbon fiber can be used after surface treatment of all or a portion if necessary. Examples of the surface treatment include oxidation treatment, nitriding treatment, nitration, sulfonation, and treatments in which a metal, metal compound, organic compound, or the like is attached or bonded to a functional group introduced to the surface by these treatments or to the surface of the carbon fiber. Examples of the functional group include hydroxyl groups, carboxyl groups, carbonyl groups, nitro groups, amino groups, and the like.

Furthermore, the average fiber length (average longer axis length) of the carbon fiber is not limited and can be appropriately selected, but from the viewpoint of ensuring high thermal conductivity, the range is preferably 50 μm to 300 μm, more preferably a range of 75 μm to 275 μm, and particularly preferably in a range of 90 μm to 250 μm.

Furthermore, there is no particular limitation to the average fiber diameter (average shorter axis length) of the carbon fibers, which may be selected as appropriate, but from the viewpoint of ensuring high thermal conductivity, the range is preferably 4 μm to 20 μm and more preferably a range of 5 μm to 14 μm.

The aspect ratio (average longer axis length/average shorter axis length) of the carbon fiber is preferably 8 or more and more preferably 9 to 30, from the viewpoint of ensuring high thermal conductivity. If the aspect ratio is less than 8, the thermal conductivity may decrease due to the short fiber length (longer axis length) of the carbon fibers, but if the aspect ratio is more than 30, the dispersibility of the carbon fibers in the thermally conductive sheet 1 may decrease, and thus sufficient thermal conductivity may not be obtained.

The average longer axis length and the average shorter axis length of the carbon fiber can be measured by, for example, a microscope, scanning electron microscope (SEM), or the like, and the average can be calculated from a plurality of samples.

The amount of fibrous thermally conductive filler in the thermally conductive sheet 1 is not particularly limited, and can be selected based on the objective, but is preferably from 4% to 40% by volume, more preferable from 5% to 35% by volume. If the amount is less than 4% by volume, obtaining sufficiently low thermal resistance will be difficult, but if the amount is more than 40% by volume, the formability of the thermally conductive sheet 1 and the alignment of the fibrous thermally conductive filler may be affected. Furthermore, the amount of the thermally conductive filler, including the fibrous thermally conductive filler, in the thermally conductive sheet 1 is preferably from 15% to 75% by volume.

The fibrous thermally conductive filler is exposed on the front and back surfaces 2a, 2b of the sheet body 2 and is in thermal contact with a heat source such as an electronic component or a heat dissipating member such as a heat sink. If the fibrous thermally conductive filler exposed on the front and back surfaces 2a, 2b of the sheet body 2 is coated with uncured components of the polymer matrix component, the contact thermal resistance between the fibrous thermally conductive filler and the electronic component or the like can be reduced when the thermally conductive sheet 1 is applied to an electronic component or the like.

(Inorganic Filler)

The thermally conductive sheet 1 may further include an inorganic filler as a thermally conductive filler. The thermal conductivity of the thermally conductive sheet 1 can be further enhanced and the strength of the sheet can be improved by including an inorganic filler. The inorganic filler is not particularly limited for shape, material, average particle diameter, and the like and can be appropriately selected based on the objective. Example of the shape include spherical, ellipsoidal, lumpy, granular, flattened, needle-shape, and the like. Of these, spherical and elliptical shapes are preferable in terms of fill properties, and spherical shapes are particularly preferred.

Examples of the material of the inorganic filler include aluminum nitride (AlN), silica, alumina (aluminum oxide), boron nitride, titania, glass, zinc oxide, silicon carbide, silicon, silicon oxide, metal particles, and the like. These may be used individually, or two or more may be used in combination. Of these, alumina, boron nitride, aluminum nitride, zinc oxide and silica are preferable, and alumina and aluminum nitride are particularly preferable in terms of thermal conductivity.

Furthermore, the inorganic filler can be treated with a surface treatment. If the inorganic filler is treated with a coupling agent as the surface treatment, the dispersibility of the inorganic filler is improved and the flexibility of the thermally conductive sheet 1 is improved.

The average particle diameter of the inorganic filler can be selected based on the type of inorganic material and the like. If the inorganic filler is alumina, the average particle diameter is preferably 1 μm to 10 μm, more preferably 1 μm to 5 μm, and particularly preferably 4 μm to 5 μm. If the average particle diameter is less than 1 μm, the viscosity may increase and filler may become difficult to blend. On the other hand, if the average particle diameter exceeds 10 μm, the thermal resistance of the thermally conductive sheet 1 may increase.

Furthermore, if the inorganic filler is aluminum nitride, the average particle diameter is preferably 0.3 μm to 6.0 μm, more preferably 0.3 μm to 2.0 μm, and particularly preferably 0.5 μm to 1.5 μm. If the average particle diameter is less than 0.3 μm, the viscosity may increase and blending may be difficult, and if the diameter exceeds 6.0 μm, the thermal resistance of the thermally conductive sheet 1 may increase.

The average particle size of the inorganic filler can be measured by, for example, a particle size distribution meter and a scanning electron microscope (SEM).

(Other Components)

In addition to the polymer matrix component, the fibrous thermally conductive filler, and the optionally included of inorganic filler, the thermally conductive sheet 1 can also include other components as appropriate based on the objective. Examples of other components include magnetic metal powders, thixotropy imparting agents, dispersing agents, curing accelerators, retardants, minimal adhesiveness imparting agents, plasticizers, flame retardants, antioxidants, stabilizers, colorants, and the like. Furthermore, the thermally conductive sheet 1 may be provided with electromagnetic wave absorption capability by adjusting the amount of the magnetic metal powder.

### [Adhesive Layer 5]

The adhesive layer 5 formed on at least one surface of the sheet body 2 imparts tackiness to at least one surface of the thermally conductive sheet 1. In the thermally conductive sheet 1 shown in FIG. 1, the adhesive layer 5 is formed on the back surface 2b of the sheet body 2, and the adhesive layer 5 is not formed on the front surface 2a. The front surface 2a of the sheet body 2 on which the adhesive layer 5 is not formed is provided with non-adhesiveness to improve the handling properties.

The material of the adhesive layer 5 is not particularly limited and may be appropriately selected depending on the intended purpose. For example, acryl-based, rubber-based, polyester-based and silicon-based, etc., may be mentioned, but from the viewpoint of close adhesion between the heat-generating surface and the heat sink surface of the electronic part and weatherability, an acryl-based adhesive liquid can preferably be used. In addition, the adhesive composition constituting the adhesive layer 5 includes, for example, an acrylic polymer called a base polymer, a cross-linking agent (for example, a polyfunctional acrylate compound, an isocyanate compound, etc.), an adhesion-imparting agent (for example, rosin), a polymerization initiator, or solvents, etc.

The volume of the adhesive layer 5 is 0.0002 cm³ or more and 0.001 cm³ or less per 1 cm² of the sheet body 2. If the volume of the adhesive layer 5 is less than 0.0002 cm³ per 1 cm² of the sheet body 2, the tackiness on the sheet surface becomes insufficient. In addition, if the volume of the adhesive layer exceeds 0.001 cm³ per 1 cm² of the sheet body 2, the thermal resistance may increase and the thermal conductivity may deteriorate. The film thickness that fills the volume of the adhesive layer 5 is 2 μm or more and 10 μm or less, assuming that the adhesive layer 5 is formed with a substantially uniform thickness.

In addition, when the adhesive layer 5 is formed unevenly, the volume of the adhesive layer 5 when formed at a thickness of 20 μm is 0.0005 cm³ or more and 0.001 cm³ or less per 1 cm² of the sheet body 2.

As a forming method, the adhesive layer 5 can be formed by spraying a liquid adhesive composition onto the sheet body 2.

### [Method for Producing the Thermally Conductive Sheet]

Next, the method for producing the thermally conductive sheet 1 will be described. In the production process of the thermally conductive sheet 1 to which the present technology is applied, there is a step of forming a thermally conductive molded body by molding a thermally conductive resin composition containing a fibrous thermally conductive filler in a polymer matrix component into a predetermined shape and curing the composition (step A), a step of slicing the thermally conductive molded body into a sheet to form a molded body sheet (step B), and a step of forming the adhesive layer on at least one surface of the molded body sheet (step C). In addition, the method for producing the thermally conductive sheet 1 may include a step of smoothing the surface of the sheet body 2 by pressing the molded body sheet, if necessary (step D).

(Step A)

In this step A, the above-mentioned polymer matrix component, fibrous thermally conductive filler, optionally contained inorganic filler and other components are blended to prepare a thermally conductive resin composition. The procedure for blending and preparing each component is not particularly limited. For example, a thermally conductive resin composition is prepared by adding a fibrous thermally conductive filler, an inorganic filler, a magnetic metal powder and other components as appropriate to the polymer matrix component and mixing them.

Next, a fibrous thermally conductive filler such as carbon fiber is oriented in one direction. The method of aligning the filler is not particularly limited as long as it can be oriented in one direction. For example, by extruding or press-fitting the thermally conductive resin composition into a hollow mold under high shearing force, the fibrous thermally conductive filler can be oriented in one direction relatively easily, and the fibrous thermally conductive fillers have the same orientation (within ±10°).

Specific examples of the method of extruding or press-fitting the thermally conductive resin composition into a hollow mold under high shear force can include an extrusion molding method or a die molding method. The thermally conductive resin composition flows and the fibrous thermally conductive filler is oriented in the direction of flow when the thermally conductive resin composition is extruded from the die with the extrusion molding method or when the thermally conductive resin composition is pressed into the mold with the die molding method. At this time, if a slit is provided on a tip of the die, the fibrous thermally conductive filler can be aligned more easily.

The thermally conductive resin composition extruded or pressed into a hollow mold is molded into a block shape based on the shape and size of the mold and is cured by curing the polymer matrix component while maintaining the orientation of the fibrous thermally conductive filler, thereby forming a thermally conductive molded body. The thermally conductive molded body refers to a base material (molded body) for cutting out a sheet, which is the source of the thermally conductive sheet 1 obtained by cutting to a predetermined size.

The size and shape of the hollow mold and the thermally conductive molded body can be determined based on the target size and shape of the thermally conductive sheet 1, for example, a rectangular solid having a cross-sectional vertical size of 0.5 cm to 15 cm and a cross-sectional horizontal size of 0.5 cm to 15 cm. The length of the rectangular solid can be determined as needed.

The method and conditions for curing the polymer matrix component can be varied depending on the type of the polymer matrix component. For example, if the polymer matrix component is a thermosetting resin, the curing temperature for thermosetting can be adjusted. Furthermore, if the thermosetting resin contains a liquid silicone gel as a main agent and a curing agent, the resin is preferably cured at a curing temperature of 80° C. to 120° C. The curing time during thermal curing is not particularly limited, but can be from 1 hour to 10 hours.

(Step B)

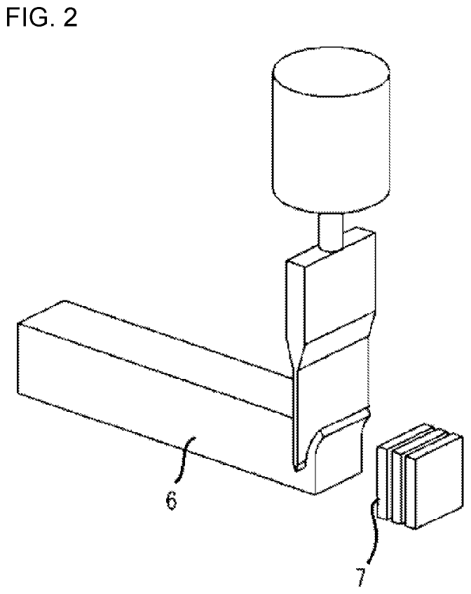

As shown in FIG. 2, in step B of slicing the thermally conductive molded body 6 into a sheet to form the molded body sheet 7, the thermally conductive molded body 6 is cut into a sheet so as to have an angle of 0° to 90° with respect to the longer axis direction of the oriented fibrous thermally conductive filler. As a result, the fibrous thermally conductive filler is oriented in the thickness direction of the sheet body 2.

Furthermore, cutting of the thermally conductive molded body 6 is performed using a slicing device. The slicing device is not particularly limited so long as being means capable of cutting the thermally conductive molded body 6, and any known slicing device can be used as appropriate. For example, an ultrasonic cutter, plane, or the like can be used.

The slice thickness of the thermally conductive molded body 6 is the thickness of the sheet body 2 of the thermally conductive sheet 1 and can be set as appropriate based on the application of the thermally conductive sheet 1 and, for example, is 0.5 to 3.0 mm.

In step B, a plurality of small pieces of the molded body sheet 7 can be made by cutting molded body sheets 7 which were cut from the thermally conductive molded body 6.

(Step C)

In step C, the adhesive layer 5 is formed by spraying a liquid adhesive composition on at least one surface of the molded body sheet 7. In addition, the volume of the adhesive layer 5 is formed so as to be 0.0002 cm³ or more and 0.001 cm³ or less per 1 cm² of the sheet body 2.

The film thickness that meets the volume of the adhesive layer 5 is 2 μm or more and 10 μm or less. The film thickness can be adjusted by controlling the discharge amount and spray rate of the spray coating device. This film thickness is based on the premise that the adhesive layer 5 is formed with a substantially uniform thickness.

Even when the adhesive layer 5 is coarse and the film thickness is uneven, the volume of the adhesive layer 5 formed so as to be 0.0002 cm³ or more and 0.001 cm³ or less per 1 cm² of the sheet body 2. For example, when the adhesive layer 5 is coarsely formed, the adhesive layer 5 is formed so that the volume is 0.0005 cm³ or more and 0.001 cm³ or less per 1 cm² of the sheet body by making the thickness 20 μm.

The volume V (cm³) of the adhesive layer 5 can be calculated by the following formula.

Volume V=(weight of molded body sheet before forming the adhesive layer−weight of molded body sheet after forming the adhesive layer)/specific gravity of the adhesive layer

In addition, the volume v (cm³) around 1 cm² of the molded body sheet 7 can be calculated by the following formula.

Volume v=(weight of molded body sheet before forming the adhesive layer−weight of molded body sheet after forming the adhesive layer)/specific gravity of the adhesive layer/sheet area

In the thermally conductive sheet 1 produced through the above processes, an adhesive layer 5 is formed on the surface of the sheet body 2, which is the sliced surface, to impart tackiness. As a result, the thermally conductive sheet 1 has improved handling property and workability.

(Step D)

The production process of the thermally conductive sheet 1, if necessary, after step B and before step C, may have a step D, wherein by sticking release films on both surfaces of the molded body sheet 7 and pressing, the surface of the sheet is smoothed and the fibrous thermally conductive filler exposed on the surface of the sheet is coated with the uncured component of the polymer matrix component. As a result, the thermally conductive sheet 1 reduces the unevenness of the sheet surface, enables the adhesive layer 5 to be formed evenly in step C, improves close adhesiveness between the heat source and heat dissipation member, can reduce the interfacial contact resistance under a light load and improves the thermal conduction efficiency.

The pressing can be performed, for example, by a set of pressing devices including a flat plate and a press head with a flat surface. Furthermore, a pinch roller may also be used to perform pressing.

The pressure during pressing is not particularly limited but can be selected as appropriate based on the objective, but if the pressure is too low, the thermal resistance tends to be the same as without pressing and if the pressure is too high, the sheet tends to be stretched, and therefore, a pressure range of 0.1 MPa to 100 MPa is preferable, and a pressure range of 0.5 MPa to 95 MPa is more preferable.

As the release film to be attached to both surfaces of the molded body sheet 7, for example, a PET film is used. In addition, the release film may be subjected to a release treatment on the surface to be attached to the surface of the molded body sheet 7. After the release film is peeled off, the molded body sheet 7 is subjected to the above-mentioned step C forming the adhesive layer 5.

### Usage Pattern Example

In actual use, the thermally conductive sheet 1 is attached, for example, to electronic components such as a semiconductor device or the inside of various electronic devices. At this time, the thermally conductive sheet 1 has excellent handling properties because the tackiness is reduced or lost on the surface of the sheet body 2 or plastic film 11 is attached, and by forming the adhesive layer 5 on one surface, it also has tackiness and is excellent in terms of workability.

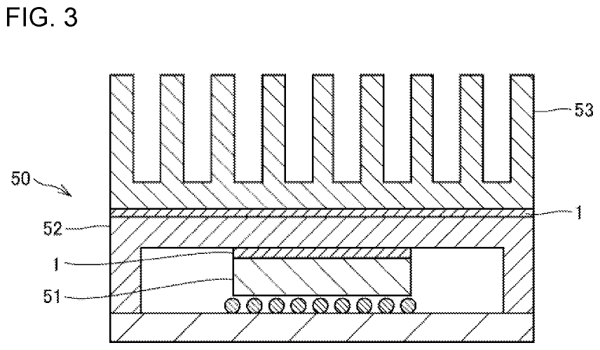

As shown in FIG. 3, for example, the thermally conductive sheet 1 is mounted on a semiconductor device 50 built in various electronic equipment and is sandwiched between a heat source and a heat-dissipating member. The semiconductor device 50 shown in FIG. 3 has at least one electronic part 51, a heat spreader 52, and a thermally conductive sheet 1, and the thermally conductive sheet 1 is sandwiched between the heat spreader 52 and the electronic part 51. By using the thermally conductive sheet 1, the semiconductor device 50 has high heat dissipation and also has an excellent electromagnetic wave suppression effect depending on the content of the magnetic metal powder in the sheet body 2.

The electronic component 51 is not particular limited and can be selected as appropriate based on the objective, and examples include various semiconductor elements such as a CPU, MPU, graphic computing element, or image sensor; antenna elements; batteries; and the like. The heat spreader 52 is not particularly limited so long as being a member that dissipates the heat emitted by the electronic component 51 and can be appropriately selected based on the objective. The thermally conductive sheet 1 is sandwiched between the heat spreader 52 and the electronic component 51. Furthermore, the thermally conductive sheet 1 forms a heat dissipating member that dissipates the heat of the electronic component 51 with the heat spreader 52 when sandwiched between the heat spreader 52 and a heat sink 53.

The mounting location of the thermally conductive sheet 1 is not limited to being between the heat spreader 52 and the electronic component 51 or between the heat spreader 52 and the heat sink 53 but can of course be selected as appropriate, based on the configuration of the electronic device or semiconductor device. In addition to the heat spreader 52 and the heat sink 53, the heat dissipating member can be any member that conducts the heat generated by the heat source and dissipates that heat outside, such as a radiator, cooler, die pad, printed circuit board, cooling fan, Peltier element, heat pipe, metal cover, housing, and the like.

### First Embodiment

Next, a first embodiment of the present technology will be described. In the first embodiment, a silicone composition (thermally conductive resin composition) was prepared by blending a two-component addition-reaction type liquid silicone with 23% by volume of aluminum nitride particles with an average particle diameter of 1 μm coupling treated with a silane coupling agent, 20% by volume of alumina particles with an average particle diameter of 5 μm, and 22% by volume of pitch-based carbon fibers with an average fiber length of 150 μm as a fibrous filler to prepare a silicone composition (thermally conductive resin composition). The two-component addition-reaction type liquid silicone resin contains an organopolysiloxane as a main component, and is formulated so that the ratio of silicone agent A:silicone agent B is 17.5 vol %:17.5 vol %. The obtained silicone composition was extrusion molded into a hollow square column mold (50 mm×50 mm) with a release-treated film applied along the inner wall of the mold to form a 50 mm square silicone molding body, and then heated in an oven at 100° C. for 6 hours to form a silicone cured product (thermally conductive molding body). After removing the cured silicone product from the hollow square columnar mold, the release-treated film was peeled off and cut into a sheet with a slicer to a thickness of 0.5 mm. The molded body sheet obtained by slicing was sandwiched between release films and pressed under the conditions of a pressure of 0.5 MPa, a temperature of 87° C. and a time of 3 minutes. After pressing, the release film on one surface was peeled off, an acrylic adhesive liquid was spray-applied, and the sheet was dried at room temperature for 1 minute, and a thermally conductive sheet having an adhesive layer formed on one surface was obtained.

Using the weight of the thermally conductive sheet obtained (50 mm×50 mm×0.5 mm), after placing the adhesive layer side on an SUS plate, it was checked whether or not it would fall when it was inverted 180 degrees. If it did not fall for 1 minute, it was evaluated as having tackiness, and if it fell within 1 minute, it was evaluated as having no tackiness.

In addition, the thermal resistance of a thermally conductive sheet that had been cut to an outer diameter of 20 mm [° C.·cm²/W] was measured under a load of 1 kgf/cm² by a method conforming to ASTM-D5470.

### Example 1

The adhesive layer evenly formed a 2 μm thermally conductive sheet on one surface of the molded body sheet. The volume of the adhesive layer per 1 cm² of the sheet body is 0.0002 cm³/cm².

### Example 2

The adhesive layer evenly formed a 5 μm thermally conductive sheet on one surface of the molded body sheet. The volume of the adhesive layer per 1 cm² of the sheet body is 0.0005 cm³/cm².

### Example 3

The adhesive layer evenly formed a 10 μm thermally conductive sheet on one surface of the molded body sheet. The volume of the adhesive layer per 1 cm² of the sheet body is 0.001 cm³/cm².

### Comparative Example 1

A thermally conductive sheet consisting only of a molded body sheet on which the adhesive layer was not formed was formed.

### Comparative Example 2

The adhesive layer evenly formed a 1 μm thermally conductive sheet on one surface of the molded body sheet. The volume of the adhesive layer per 1 cm² of the sheet body is 0.0001 cm³/cm².

### Comparative Example 3

The adhesive layer evenly formed a 20 μm thermally conductive sheet on one surface of the molded body sheet. The volume of the adhesive layer per 1 cm² of the sheet body is 0.002 cm³/cm².

### Comparative Example 4

The adhesive layer evenly formed a 30 μm thermally conductive sheet on one surface of the molded body sheet. The volume of the adhesive layer per 1 cm² of the sheet body is 0.003 cm³/cm².

### Comparative Example 5

A thermally conductive sheet was formed on the molded body sheet by attaching an acrylic adhesive tape having the adhesive layer with a thickness of 20 μm laminated on a support. The volume of the adhesive layer per 1 cm² of the sheet body is 0.002 cm³/cm².

TABLE 1

| | | | | | Thermal | |
|---|---|---|---|---|---|---|
| | | | | | resistance increase | |
| | | Adhesive | Adhesive | Thermal | [° C. · cm²/W] | |
| | Sheet | layer | layer | resistance | based on | |
| | thickness | thickness | volume | [° C. · cm²/W]@1 | Comparative | |
| | [mm] | [μm] | [cm³/cm²] | kgf/cm² | Example 1 | Tackiness |
| Example 1 | 0.5 | 2 | 0.0002 | 0.35 | 0 | On one surface |
| Example 2 | 0.5 | 5 | 0.0005 | 0.5 | 0.15 | On one surface |
| Example 3 | 0.5 | 10 | 0.001 | 0.75 | 0.4 | On one surface |
| Comparative Example 1 | 0.5 | 0 | 0 | 0.35 | — | None |
| Comparative Example 2 | 0.5 | 1 | 0.0001 | 0.3 | −0.05 | None |
| Comparative Example 3 | 0.5 | 20 | 0.002 | 1.25 | 0.9 | On one surface |
| Comparative Example 4 | 0.5 | 30 | 0.003 | 1.75 | 1.4 | On one surface |
| Comparative Example 5 | 0.5 | 20 (tape) | 0.002 | 1.3 | 0.95 | Tape peeled off |

As shown in Table 1, Examples 1 to 3, where the volume of the adhesive layer is 0.0002 cm³ or more and 0.001 cm³ or less per 1 cm² of the sheet body, have tackiness, and the increase in thermal resistance based on Comparative Example 1 in which the adhesive layer was not formed was also suppressed to a low level.

On the other hand, in Comparative Example 2, in which the volume of the adhesive layer was 0.0001 cm³/cm², lacked tackiness, and in Comparative Examples 2 to 5, in which the volume of the adhesive layer was 0.002 cm³/cm² or more, the thermal resistance increased, and the thermal resistance based on Comparative Example 1 increased significantly. In addition, in Comparative Example 5 in which the acrylic adhesive tape was attached to the molded body sheet, the acrylic adhesive tape was peeled off from the molded body sheet.

### Second Embodiment

Next, a second embodiment of the present technology will be described. In the second embodiment a silicone composition (thermally conductive resin composition) was prepared by blending a two-component addition-reaction type liquid silicone with 23% by volume of aluminum nitride particles with an average particle diameter of 1 μm coupling treated with a silane coupling agent, 20% by volume of alumina particles with an average particle diameter of 5 μm, and 22% by volume of pitch-based carbon fibers with an average fiber length of 150 μm as a fibrous filler to prepare a silicone composition (thermally conductive resin composition). The two-component addition-reaction type liquid silicone resin contains an organopolysiloxane as a main component, and is formulated so that the ratio of silicone agent A:silicone agent B is 17.5 vol %:17.5 vol %. The obtained silicone composition was extrusion molded into a hollow square columnar mold (50 mm×50 mm) with a release-treated film applied along the inner wall of the mold to form a 50 mm square silicone molding body, and then heated in an oven at 100° C. for 6 hours to form a silicone cured product (thermally conductive molding body). After removing the cured silicone product from the hollow square columnar mold, the release-treated film was peeled off and cut into a sheet with a slicer to a thickness of 0.5 mm. The molded body sheet obtained by slicing was sandwiched between release films and pressed under the conditions of a pressure of 0.5 MPa, a temperature of 87° C. and a time of 3 minutes. After pressing, the release film on one surface was peeled off, an acrylic adhesive liquid was spray-applied, and the sheet was dried at room temperature for 1 minute, and a thermally conductive sheet having an adhesive layer formed on one surface was obtained.

Using the weight of the thermally conductive sheet obtained (50 mm×50 mm×0.5 mm), after placing the adhesive layer side on an SUS plate, it was checked whether or not it would fall when it was inverted 180 degrees. If it did not fall for 1 minute, it was evaluated as having tackiness, and if it fell within 1 minute, it was evaluated as having no tackiness.

In addition, the thermal resistance of a thermally conductive sheet that had been cut to an outer diameter of 20 mm [° C.·cm²/W] was measured under a load of 1 kgf/cm² by a method conforming to ASTM-D5470.

### Example 4

The adhesive layer was unevenly formed on one surface of the molded body sheet to form a thermally conductive sheet having a thickness of 20 μm and an adhesive layer volume of 0.0005 cm³/cm². The volume of the adhesive layer per 1 cm² of the sheet body is 0.0005 cm³/cm².

### Example 5

The adhesive layer was unevenly formed on one surface of the molded body sheet to form a thermally conductive sheet having a thickness of 20 μm and an adhesive layer volume of 0.0001 cm³/cm². The volume of the adhesive layer per 1 cm² of the sheet body is 0.001 cm³/cm².

### Comparative Example 6

The adhesive layer was unevenly formed on one surface of the molded body sheet to form a thermally conductive sheet having a thickness of 20 μm and an adhesive layer volume of 0.00015 cm³/cm². The volume of the adhesive layer per 1 cm² of the sheet body is 0.0015 cm³/cm².

### Comparative Example 7

The adhesive layer was unevenly formed on one surface of the molded body sheet to form a thermally conductive sheet having a thickness of 20 μm and an adhesive layer volume of 0.002 cm³/cm². The volume of the adhesive layer per 1 cm² of the sheet body is 0.002 cm³/cm².

TABLE 2

| | | | | | Thermal | |
|---|---|---|---|---|---|---|
| | | | | | resistance increase | |
| | | Adhesive | Adhesive | Thermal | [° C. · cm²/W] | |
| | Sheet | layer | layer | resistance | based on | |
| | thickness | thickness | volume | [° C. · cm²/W]@1 | Comparative | |
| | [mm] | [μm] | [cm³/cm²] | kgf/cm² | Example 1 | Tackiness |
| Example 4 | 0.5 | 20 | 0.0005 | 0.5 | 0.15 | On one surface |
| Example 5 | 0.5 | 20 | 0.001 | 0.75 | 0.4 | On one surface |
| Comparative Example 6 | 0.5 | 20 | 0.0015 | 1 | 0.65 | On one surface |
| Comparative Example 7 | 0.5 | 20 | 0.002 | 1.25 | 0.9 | On one surface |

As shown in Table 2, Examples 4 to 5, where the adhesive layer was formed unevenly, the thickness was 20 μm and the volume of the adhesive layer was 0.0005 cm³ or more and 0.001 cm³ or less, have tackiness, and the increase in thermal resistance based on Comparative Example 1 in which the adhesive layer was not formed was also suppressed to a low level.

On the other hand, in Comparative Example 6, where the adhesive layer was unevenly formed, the thickness was 20 μm and the volume of the adhesive layer was 0.0015 cm³/cm², and in Comparative Example 7, where the volume of the adhesive layer was 0.002 cm³/cm², the thermal resistance increased, and the thermal resistance based on Comparative Example 1 increased significantly.

### LIST OF REFERENCE NUMERALS

1: thermally conductive sheet
2: sheet body
5: adhesive layer
6: thermally conductive molded body
7: molded body sheet

1. A thermally conductive sheet comprising:
a sheet body obtained by curing a thermally conductive resin composition comprising a polymer matrix and a fibrous thermally conductive filler dispersed in the polymer matrix; and
an adhesive layer formed on at least one surface of the sheet body and imparting tackiness to the at least one surface of the sheet body,
wherein a volume of the adhesive layer is 0.0002 cm³ or more and 0.001 cm³ or less per 1 cm² of the sheet body.

2. The thermally conductive sheet according to claim 1, wherein the adhesive layer is composed of an acrylic adhesive.

3. The thermally conductive sheet according to claim 1, wherein the adhesive layer is formed on only one surface of the sheet body.

4. The thermally conductive sheet according to claim 3, wherein a surface of the sheet body on which the adhesive layer is not formed is non-adhesive.

5. The thermally conductive sheet according to claim 1, wherein the polymer matrix comprises a liquid silicone.

6. The thermally conductive sheet according to claim 1, wherein the fibrous thermally conductive filler is a carbon fiber.

7. A method for producing a thermally conductive sheet, comprising:
molding a thermally conductive resin composition comprising a polymer matrix and a fibrous thermally conductive filler dispersed in the polymer matrix into a predetermined shape;
curing the molded thermally conductive resin composition to form a thermally conductive molded body;
slicing the thermally conductive molded body into a sheet to form a molded body sheet; and
forming an adhesive layer on at least one surface of the molded body sheet, the adhesive layer imparting tackiness to the at least one surface of the molded body sheet,
wherein a volume of the adhesive layer is 0.0002 cm³ or more and 0.001 cm³ or less per 1 cm² of a sheet body of the molded body sheet.

8. The method according to claim 7, wherein the adhesive layer is formed by applying an adhesive liquid to the at least one surface of the molded body sheet.

9. The method according to claim 8, wherein the adhesive layer is formed by spraying the adhesive liquid on the at least one surface of the molded body sheet.

10. The method according to claim 7, wherein the adhesive layer is composed of an acrylic adhesive.

11. The method according to claim 7, wherein the adhesive layer is formed on only one surface of the molded body sheet.

12. The method according to claim 11, wherein a surface of the molded body sheet on which the adhesive layer is not formed is non-adhesive.

13. The method according to claim 7, wherein the polymer matrix comprises a liquid silicone.

14. The method according to claim 7, wherein the fibrous thermally conductive filler is a carbon fiber.

15. The thermally conductive sheet according to claim 1, wherein the adhesive layer is formed unevenly, and the volume of the adhesive layer is 0.0005 cm³ or more and 0.001 cm³ or less per 1 cm² of the sheet body when the adhesive layer is formed to have a thickness of 20 μm.

16. The method according to claim 7, wherein the adhesive layer is formed unevenly, and the volume of the adhesive layer is 0.0005 cm³ or more and 0.001 cm³ or less per 1 cm² of the molded body sheet when the adhesive layer is formed to have a thickness of 20 μm.
